(19) United States
(12) Patent Application Publication
(10) Pub. No.: US 2025/0114993 A1
(43) Pub. Date: Apr. 10, 2025

(54) MOLDING PRODUCT TAKING-OUT SYSTEM, MOLDING MACHINE, CONTROL DEVICE, AND MOLDING PRODUCT TAKING-OUT METHOD

(71) Applicant: SUMITOMO HEAVY INDUSTRIES, LTD., Tokyo (JP)

(72) Inventors: Shigeru TAKEUCHI, Chiba-shi (JP); Toshihide MIYAMA, Chiba-shi (JP)

(21) Appl. No.: 18/905,119

(22) Filed: Oct. 2, 2024

(30) Foreign Application Priority Data
Oct. 10, 2023 (JP) 2023-175474

(51) Int. Cl. B29C 45/40; B29C 45/04; B29C 45/76; B29C 45/80; B29K 67/00; B29L 31/00

(52) U.S. Cl. CPC B29C 45/4005; B29C 45/0416; B29C 45/7626; B29C 45/80; B29C 2945/76568; B29C 2945/76722; B29C 2945/76896; B29K 2067/003; B29L 2031/7158

(57) ABSTRACT

A molding product taking-out system includes a molding machine that includes a stationary platen including a stationary mold and a movable platen including a movable mold, a take-out machine for taking out a molding product, and a control device, in which the control device causes the take-out machine to enter between the stationary mold and the movable mold that are opened, and moves at least one of the movable platen and the take-out machine such that the molding product relatively approaches the take-out machine.

### CROSS-REFERENCE TO RELATED APPLICATIONS

This application claims priority to Japanese Patent Application No. 2023-175474, filed on Oct. 10, 2023, which is incorporated by reference herein in its entirety.

### BACKGROUND

### Technical Field

Certain embodiments of the present invention relate to a molding product taking-out system, a molding machine, a control device, and a molding product taking-out method.

### Description of Related Art

The related art discloses a technique for taking out a molding product, such as a preform, from a mold of an injection molding machine. In the related art, a take-out machine is moved between opened molds, and the molding product ejected from the molds by an ejector unit is taken out from the molds by the take-out machine.

### SUMMARY

According to an embodiment of the present invention, there is provided a molding product taking-out system including: a molding machine that includes a stationary platen including a stationary mold and a movable platen including a movable mold; a take-out machine for taking out a molding product; and a control device. The control device causes the take-out machine to enter between the stationary mold and the movable mold that are opened, and moves at least one of the movable platen of the molding machine and the take-out machine such that the molding product relatively approaches the take-out machine.

According to another embodiment of the present invention, there is provided a molding product taking-out method. The molding product taking-out method is a method for taking out a molding product from a molding machine that includes a stationary platen including a stationary mold and a movable platen including a movable mold, the method including: causing a take-out machine to enter between the stationary mold and the movable mold that are opened; and moving at least one of the movable platen and the take-out machine such that the molding product relatively approaches the take-out machine.

Any combination of the above components or those in which the components or expressions of the present invention are replaced with each other between methods, apparatuses, systems, or the like are also effective as embodiments of the present invention.

### BRIEF DESCRIPTION OF THE DRAWINGS

FIG. 1 is a plan view showing a schematic configuration of a molding product taking-out system according to an embodiment.

FIG. 2 is a cross-sectional view taken along line A-A of the molding product taking-out system 1 shown in FIG. 1.

FIG. 3 is a diagram showing an example of a preform as a molding product.

FIG. 4 is a cross-sectional view taken along line B-B of FIG. 2.

FIG. 5 is a diagram illustrating an example of a preform taking-out operation by the molding product taking-out system in a time series.

FIG. 6 is a diagram illustrating an example of the preform taking-out operation by the molding product taking-out system in a time series.

FIG. 7 is a diagram illustrating an example of the preform taking-out operation by the molding product taking-out system in a time series.

FIG. 8 is a diagram illustrating an example of the preform taking-out operation by the molding product taking-out system in a time series.

FIG. 9 is a diagram illustrating an example of the preform taking-out operation by the molding product taking-out system in a time series.

FIG. 10 is a diagram illustrating an example of the preform taking-out operation by the molding product taking-out system in a time series.

### DETAILED DESCRIPTION

In recent years, short preforms have been molded due to lightening, that is, thinning, of PET bottles and introduction of small PET bottles with a capacity of 200 ml or less. There is a possibility that the short preform will fall through a gap between a take-out machine and a mold. Alternatively, the short preform may tilt in the gap and enter a take-out tube of the take-out machine at an angle, potentially colliding with an inner peripheral surface of the take-out tube. Since the preform immediately after being taken out is not sufficiently cooled, it deforms upon colliding with the inner peripheral surface.

Such an issue can occur not only for preforms but also for other short molding products.

It is desirable to provide a technique capable of suppressing defective take-out of a molding product.

Hereinafter, the same or equivalent components, members, and processes shown in the respective drawings will be denoted by the same reference numerals, and duplicate description will be omitted as appropriate. In addition, dimensions of the members in each drawing are shown enlarged or reduced as appropriate for easy understanding. In addition, some members that are not important for describing the embodiment will be omitted in the respective drawings.

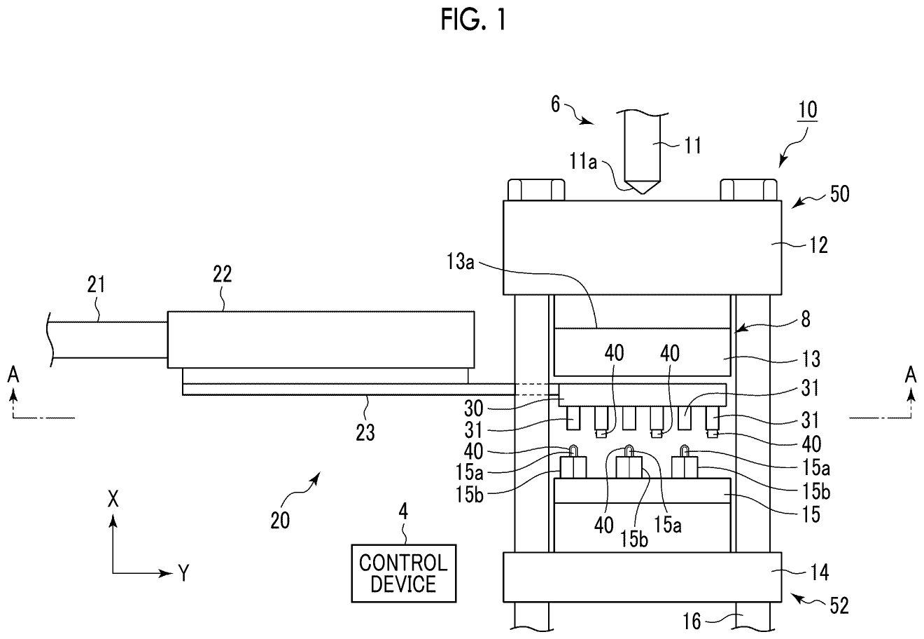

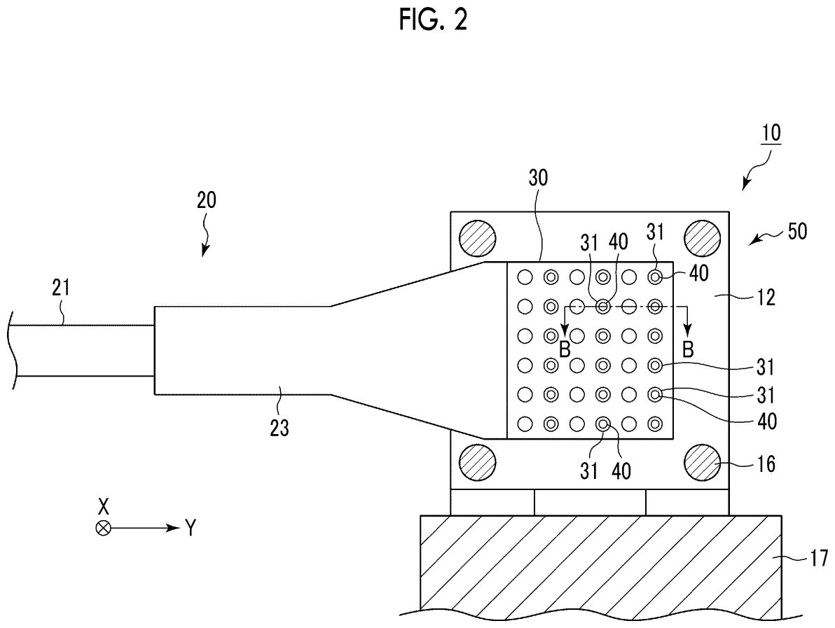

FIG. 1 is a plan view showing a schematic configuration of a molding product taking-out system 1 according to an embodiment. FIG. 2 is a cross-sectional view taken along line A-A of FIG. 1. An X-axis direction and a Y-axis direction are defined as illustrated. The X-axis direction and the Y-axis direction are perpendicular to each other. The X-axis direction coincides with an opening and closing direction of a mold 8. The Y-axis direction coincides with a direction in which a robot 20 moves a take-out machine. A positive direction of each of an X-axis and a Y-axis is defined by a direction of an arrow in each drawing, and a negative direction is defined as a direction opposite to the arrow.

The molding product taking-out system 1 includes a molding machine 2 that molds a molding product, a take-out machine 30 that takes out the molding product from the molding machine 2, the robot 20 that moves the take-out machine 30, and a control device 4.

In the present embodiment, a case where the molding product is a preform used for blow forming, particularly a short preform, will be described as an example. The preform is heated to a certain temperature in a blow forming process which is not described in the present embodiment, air is blown into the preform, and the preform is expanded and molded into a container such as a bottle or another hollow member. The technical concept of the present embodiment can be applied to molding products other than preforms, particularly short molding products, as long as there is no contradiction.

The molding machine 2 includes a mold clamping unit 10, a stationary platen 50 fixed to a support frame 17, a movable platen 52 that is attached to be movable with respect to the stationary platen 50, and an injection unit 6 that injects a molding material.

The stationary platen 50 includes a stationary platen body 12 and a stationary mold 13. The movable platen 52 includes a movable platen body 14 and a movable mold 15. The stationary mold 13 and the movable mold 15 constitute the mold 8.

The stationary mold 13 is attached to the stationary platen body 12. The movable mold 15 is attached to the movable platen body 14. The movable mold 15 includes a protrusion portion 15a shaped to correspond to a cavity portion (to be described later) of a preform 40. The stationary mold 13 includes a recessed portion (not shown) with a depth sufficient to accommodate the protrusion portion 15a. A cavity space for the preform 40 is formed between the protrusion portion 15a and the recessed portion.

The movable platen body 14 is driven by a driving device (not shown) and moves in the X-axis direction along a tie bar 16. The movable platen body 14 is moved with respect to the stationary platen body 12, so that the mold 8 is closed, clamped, and opened.

The injection unit 6 includes a cylinder 11 with a nozzle 11a at a tip thereof. The injection unit 6 is driven by a drive unit (not shown) to move in the X-axis direction, approaching or separating from the stationary platen body 12 and hence the mold 8. The injection unit 6 inserts the nozzle 11a into a through-hole (not shown) formed in the stationary platen body 12 and injects the molding material into the cavity space of the mold 8 while the nozzle 11a is pressed against a spool bush (not shown) attached to a surface 13a of the stationary mold 13 on a side opposite to the movable mold 15. The molding material filled in the cavity space solidifies, thereby obtaining the preform 40 as a molding product. For example, the number of the cavity spaces is a plurality, and a plurality of the preforms 40 are obtained simultaneously. When the mold 8 is opened, the preforms 40 are attached around a plurality of the protrusion portions 15a of the movable mold 15.

The take-out machine 30 moves between the stationary mold 13 and the movable mold 15 of the opened mold 8. The take-out machine 30 is attached to a tip end arm 23 of the robot 20 and reciprocates in the Y-axis direction. The robot 20 includes a slide unit 22 that is slidably attached to a guide arm 21 attached to a main body portion (not shown). The tip end arm 23 attached to the slide unit 22 is moved by moving the slide unit 22 along the guide arm 21.

The take-out machine 30 includes a take-out tube 31. In the illustrated example, the take-out machine 30 includes a plurality of the take-out tubes 31. The plurality of take-out tubes 31 are each attached at a position corresponding to each of the protrusion portions 15a of the movable mold 15. The take-out tube 31 accommodates the preform 40 delivered from the movable mold 15. In a state in which the preform 40 is accommodated inside the take-out tube 31, the take-out machine 30 is retracted from between the stationary mold 13 and the movable mold 15, so that a plurality of the preforms 40 can be simultaneously taken out from the mold 8.

The control device 4 can be realized by cooperation of hardware resources and software resources, or by hardware resources alone. As the hardware resources, elements or circuits such as a central processing unit (CPU) and a memory can be used. As the software resources, programs such as operating systems and applications can be used.

The control device 4 integrally controls the molding product taking-out system 1. That is, the control device 4 controls the molding machine 2, the take-out machine 30, and the robot 20. For example, the control device 4 controls the driving device to move the movable platen body 14 with respect to the stationary platen body 12. For example, the robot 20 is controlled to move the take-out machine 30 to a space between the molds 8 as shown in FIG. 1, or to retract the take-out machine 30 from the space between the molds 8.

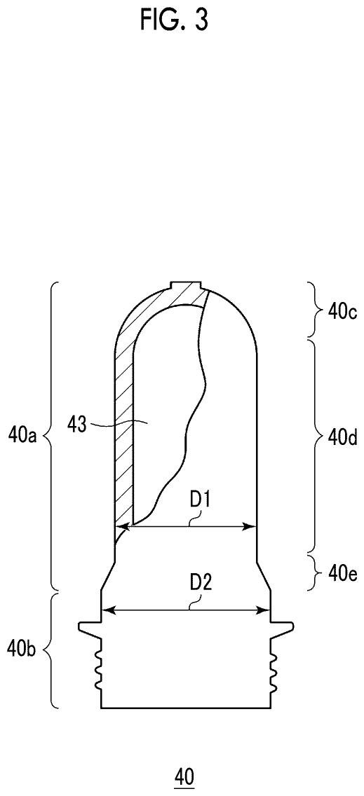

An example of the preform 40 as a molding product will be described with reference to FIG. 3. The preform 40 shown in FIG. 3 is intended for molding a bottle and is molded using PET resin. The preform 40 includes a body portion 40a which is expanded in the blow forming process to become a body part of a bottle for accommodating a liquid, and a neck portion 40b which remains substantially unexpanded in the blow forming process to become a mouth part provided with threads on which a cap is screwed. A cavity portion 43 is formed inside the body portion 40a.

In this example, the body portion 40a includes a semi-spherical tip portion 40c, a cylindrical portion 40d, and an enlarged diameter portion 40e whose outer diameter increases toward the neck portion 40b. It is also conceivable that the body portion 40a does not include the enlarged diameter portion 40e. In this case, an outer diameter D1 of the cylindrical portion 40d and an outer diameter D2 of the neck portion 40b may be different from each other as in the illustrated example, or may be the same as each other. In addition, the cylindrical portion 40d may have a draft angle for production considerations, regardless of whether the body portion 40a includes the enlarged diameter portion 40e, and specifically, may be formed such that the outer diameter very slightly decreases as the cylindrical portion 40d approaches the tip portion 40c.

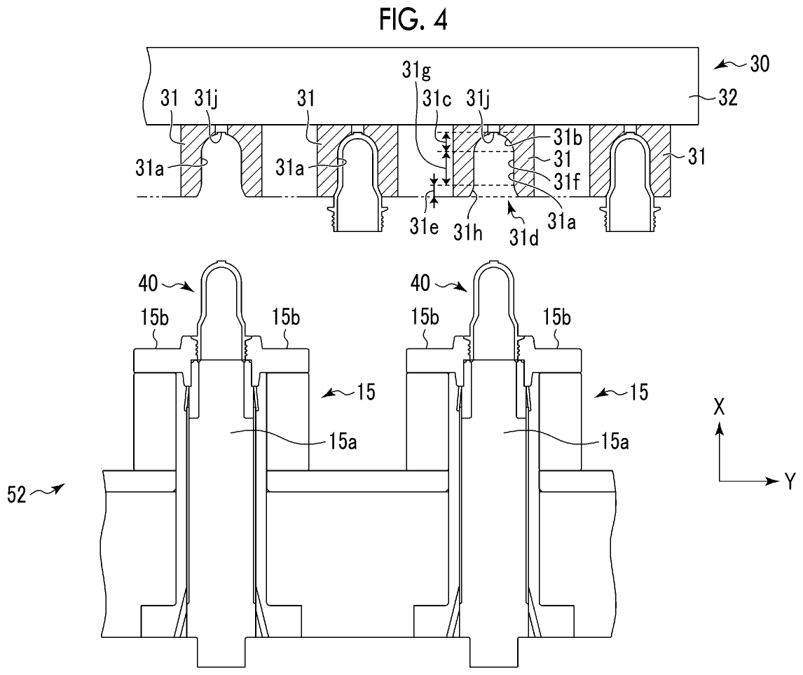

FIG. 4 is a cross-sectional view taken along line B-B of FIG. 2. The take-out machine 30 includes a plate 32 and a plurality of the take-out tubes 31 attached to the plate 32. The take-out tube 31 includes an accommodation hole 31a that accommodates the preform 40. The accommodation hole 31a includes a bottom portion 31c having a semi-spherical bottom surface 31b, an inlet portion 31e having an opening 31d, and an intermediate portion 31g having a cylindrical inner peripheral surface 31f located between the bottom portion 31c and the inlet portion 31e. The inlet portion 31e is formed such that a diameter thereof increases toward the opening. A suction port 31j is formed in the bottom surface 31b. Air is suctioned from the suction port by a suction source (not shown). Accordingly, the preform 40 is held in the accommodation hole.

A flow path (not shown) is formed in the take-out tube 31. A refrigerant such as cold water flows through the flow path. Accordingly, the take-out tube 31 and hence the preform 40 accommodated in the take-out tube 31 are cooled. That is, the take-out machine 30 is of a liquid-cooled type.

In FIG. 4, the preform 40 molded one cycle earlier is held in every other take-out tube 31. This is intended to cause the preform 40 to be held in the take-out tube 31 for one cycle longer, so that the preform 40 is cooled in the take-out tube 31 through which the refrigerant flows. The preform 40 molded two or more cycles earlier may be held.

The movable mold 15 includes the protrusion portion 15a and a pair of split molds 15b corresponding to the neck portion 40b of the preform 40. The pair of split molds 15b are driven by a drive unit (not shown) and move toward the take-out tube 31 as will be described later. Accordingly, the preform 40 is in a state of not being fitted to the protrusion portion 15a and moves toward the take-out tube 31.

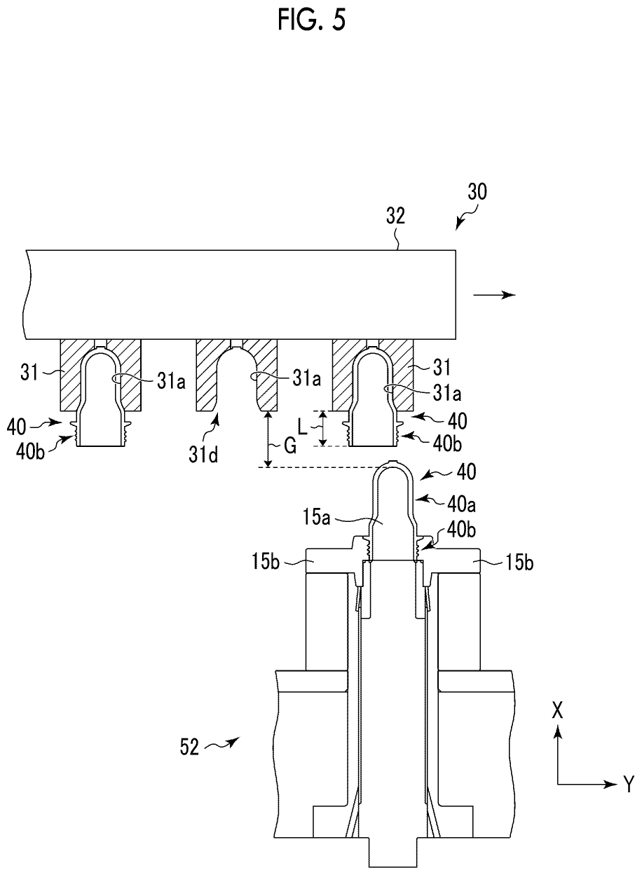

Subsequently, a taking-out operation of the preform 40 by the molding product taking-out system 1 will be described. FIGS. 5 to 10 show an example of the taking-out operation of the preform 40 by the molding product taking-out system 1 in a time series.

In FIG. 5, the take-out machine 30 is moving between the stationary mold 13 and the movable mold 15 of the opened mold 8. The preform 40 molded at least one cycle earlier is held in a part of the plurality of take-out tubes 31 of the take-out machine 30. The preform 40 molded in a current cycle is held in the movable mold 15. That is, the preform 40 molded in the current cycle is fitted to the protrusion portion 15a and is gripped by the pair of split molds 15b.

A predetermined gap G independent of a length of the body portion 40a of the preform 40 is secured between the take-out tube 31 and the protrusion portion 15a to ensure that neither the take-out tube 31 of the take-out machine 30 nor the neck portion 40b of the preform 40 held in the take-out tube 31 comes into contact with the protrusion portion 15a of the movable mold 15 or with the preform 40 adhering to the protrusion portion 15a when the take-out machine 30 moves to the space between the molds 8. A size of the gap G may be determined based on a dimension L of the neck portion 40b of the preform 40.

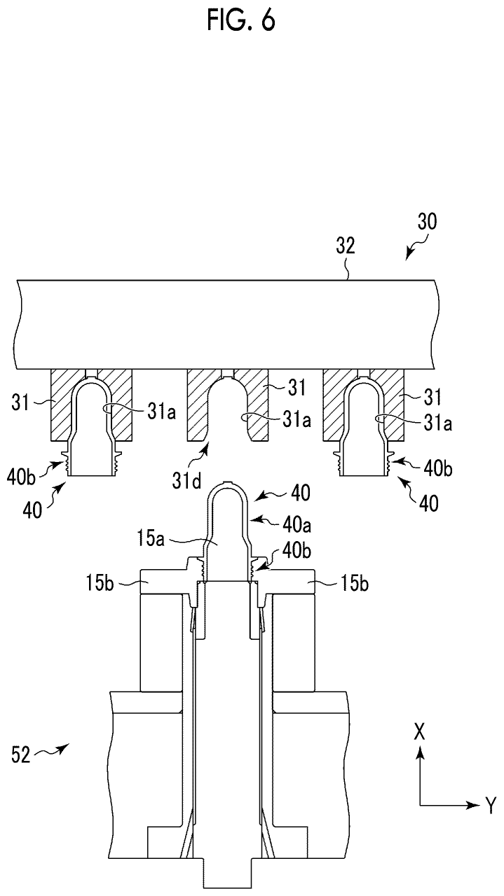

In FIG. 6, the movement of the take-out machine 30 is completed, and the take-out tube 31 faces the corresponding protrusion portion 15a in the X-axis direction.

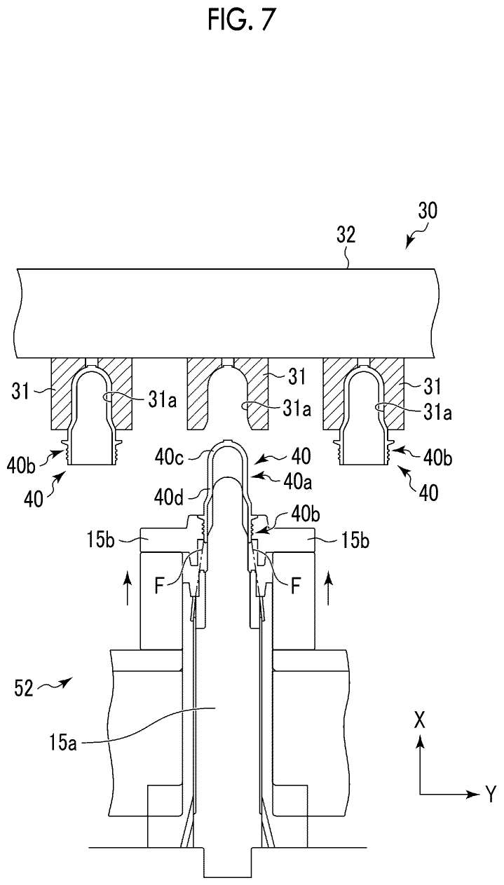

In FIG. 7, the pair of split molds 15b gripping the preform 40 are moved in the positive direction of the X-axis. That is, the pair of split molds 15b are moved toward the take-out tube 31 along with each preform 40. As a modification example, the movement of the preform 40 by the pair of split molds 15b may be started at the same time as the movement of the take-out machine 30 to the space between the molds 8 is completed, or may be started before the movement of the take-out machine 30 to the space between the molds 8 is completed (for example, immediately before the completion) as long as no contact occurs.

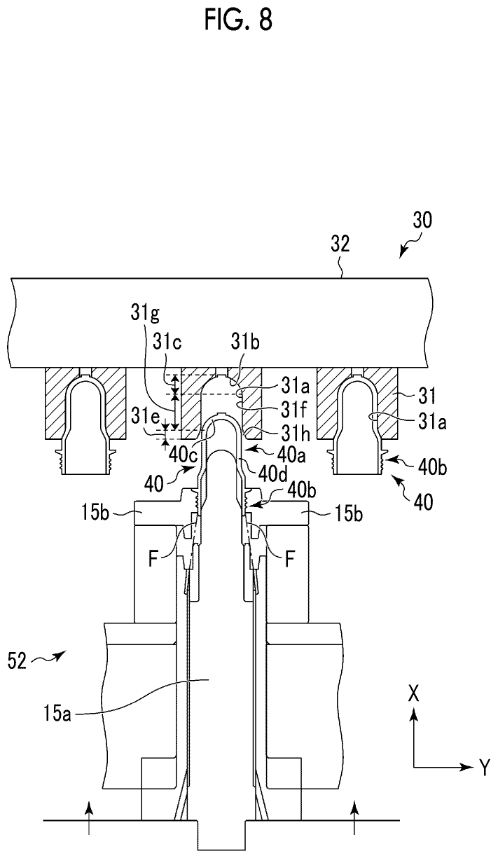

In FIG. 8, the movable platen body 14 is moved in the positive direction of the X-axis. That is, the movable mold 15 and hence the preform 40 are moved toward the take-out tube 31 of the movable platen body 14.

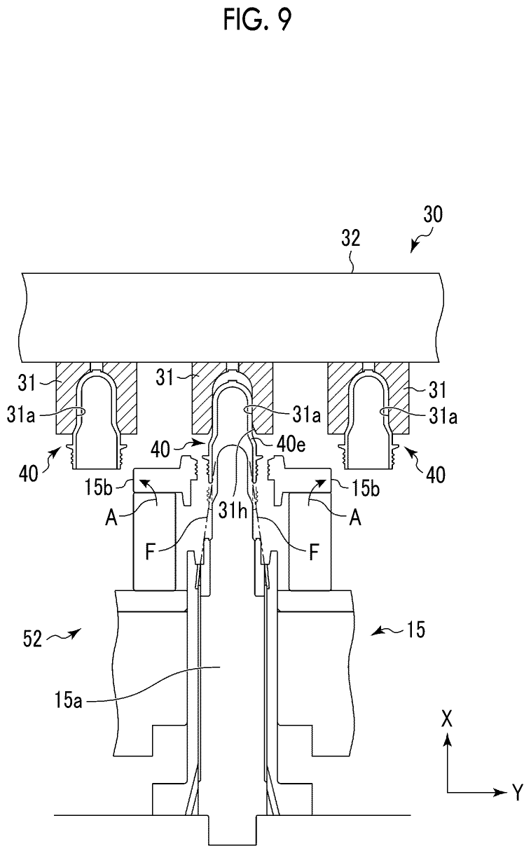

In FIG. 9, as indicated by an arrow A in the drawing, the pair of split molds 15b are moved in the positive direction of the X-axis, that is, toward the take-out machine 30, and the pair of split molds 15b are opened to be separated from each other in the Y-axis direction. Accordingly, the preform 40 is in a state of not being fitted to the protrusion portion 15a, and is then not gripped by the pair of split molds 15b. The preform 40 is sucked into the accommodation hole 31a by suction.

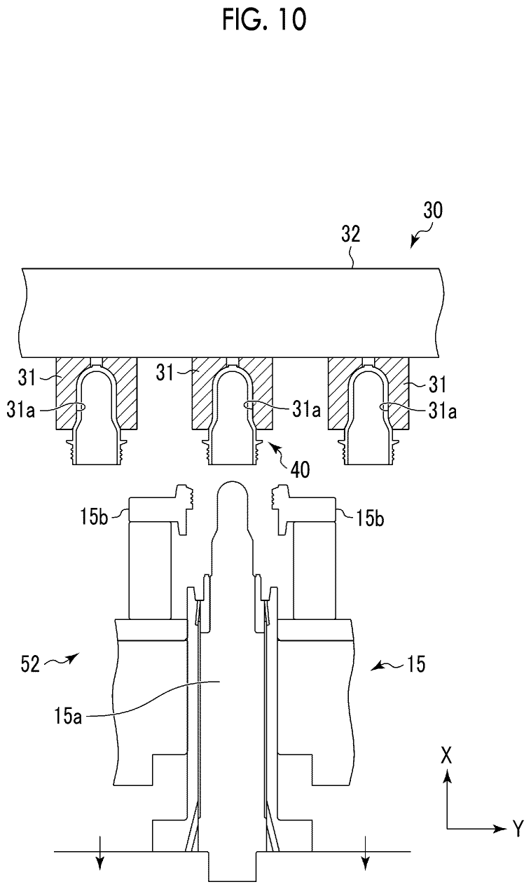

In FIG. 10, the movable platen body 14 is moved in the negative direction of the X-axis. Accordingly, the protrusion portion 15a comes out of the preform 40, and, in other words, the protrusion portion 15a does not overlap with the preform 40. Therefore, the take-out machine 30 can be removed from between the stationary mold 13 and the movable mold 15 of the opened mold 8.

In the taking-out operation described above, the movable platen 52 is moved such that the preform 40 moves toward the take-out tube 31. Accordingly, the preform 40 is brought close to the take-out tube 31, and it is possible to prevent the preform 40 from falling when the preform 40 is delivered from the mold 8 to the take-out tube 31. The movement of the movable platen 52 referred to here includes the movement of the pair of split molds 15b in the positive direction of the X-axis and the movement of the movable platen body 14 in the positive direction of the X-axis.

Preferably, when the preform 40 is no longer held in the movable mold 15 in FIG. 9, the movable platen 52 is moved such that at least a part of the tip portion 40c of the preform 40 is located inside the inlet portion 31e of the take-out tube 31. Accordingly, falling of the preform 40 can be more reliably prevented.

Here, a state in which the preform 40 is not held in the movable mold 15 refers to a state in which the preform 40 is neither fitted to the protrusion portion 15a nor gripped by the pair of split molds 15b. Therefore, “when the preform 40 is no longer held in the movable mold 15” is when the preform 40 is no longer gripped by the pair of split molds 15b, and, for example, may be when the pair of split molds 15b open to be separated from each other in the Y-axis direction.

More preferably, when the preform 40 is no longer held in the movable mold 15 in FIG. 9, the movable platen 52 is moved such that at least a part of the tip portion 40c of the preform 40 is located inside the intermediate portion 31g of the take-out tube 31. Accordingly, falling of the preform 40 can be more reliably prevented. In addition, it is possible to prevent a collision between the preform 40 and an inner peripheral surface of the take-out tube 31, for example, a collision between the tip portion 40c of the preform 40 and an inner peripheral surface 31h of the inlet portion 31e of the take-out tube 31.

More preferably, the movable platen 52 is moved such that at least a part of the cylindrical portion 40d of the preform 40 is located inside the intermediate portion 31g of the take-out tube 31 when the preform 40 is not held in the movable mold 15 in FIG. 9. Accordingly, it is possible to more reliably prevent the preform 40 from falling and colliding with the inner peripheral surface 31h of the take-out tube 31.

Although not particularly limited, air F may be blown to the preform 40 from the movable mold 15 at an appropriate timing in FIGS. 7 to 9 to assist the movement of the preform 40.

In the example described above, a case has been described where the preform 40 is moved toward the take-out tube 31 by the split molds 15b, and then the preform 40 is further moved toward the take-out tube 31 by the movable platen body 14. However, a timing at which the split molds 15b and the movable platen body 14 move the preform 40 is not limited thereto.

For example, the preform 40 may be moved toward the take-out tube 31 by the movable platen body 14, and then the preform 40 may be further moved toward the take-out tube 31 by the split molds 15b. In this case, the preform 40 may enter the take-out tube 31 when the preform 40 has moved by the movable platen body 14, or the preform 40 may enter the take-out tube 31 when the preform 40 has moved by the split molds 15b. The movement of the preform 40 by the movable platen body 14 may be started at the same time as or after the movement of the take-out machine 30 to the space between the molds 8 is completed, or may be started before the movement of the take-out machine 30 to the space between the molds 8 is completed as long as no contact occurs.

In addition, for example, the movement of the preform 40 by the split molds 15b and the movement of the preform 40 by the movable platen body 14 may be executed simultaneously. In this case, the movement of the preform 40 by the split molds 15b and the movement of the preform 40 by the movable platen body 14 may be started at the same time, the movement of the preform 40 by the split molds 15b may be started first, or the movement of the preform 40 by the movable platen body 14 may be started first. In addition, the movement of the preform 40 by the split molds 15b and the movement of the preform 40 by the movable platen body 14 may be simultaneously ended, the movement of the preform 40 by the split molds 15b may be ended first, or the movement of the preform 40 by the movable platen body 14 may be ended first. The movement of the preform 40 by the split molds 15b or the movable platen body 14 may be started at the same time as or after the movement of the take-out machine 30 to the space between the molds 8 is completed, or may be started before the movement of the take-out machine 30 to the space between the molds 8 is completed as long as no contact occurs.

According to the present embodiment described above, the movable platen 52 is moved such that the preform 40 moves toward the take-out tube 31. Accordingly, the preform 40 approaches the take-out tube 31. For example, the preform 40 enters the take-out tube 31. Therefore, it is possible to prevent the preform 40 from falling when the preform 40 is delivered from the mold 8 to the take-out tube 31 and to prevent the preform 40 from colliding with the inner peripheral surface of the take-out tube 31.

It is also conceivable to move the take-out machine 30 to bring the preform 40 and the take-out tube 31 close to each other. However, in this case, a mechanism for moving and stopping the take-out machine 30 in the X-axis direction and ensuring a position of the take-out machine 30 in the X-axis direction is required, which incurs additional costs. In some cases, it is necessary to add a shaft to move the take-out machine 30 in the X-axis direction, which increases the number of components and a weight, that is, an inertia of the take-out machine 30. When the number of components increases, costs increase. When the inertia of the take-out machine 30 increases, power required for braking the take-out machine 30 increases, thereby increasing power consumption. In addition, when the inertia of the take-out machine 30 increases, a time required for braking the take-out machine 30 becomes longer. Therefore, a time required for the movement of the take-out machine 30 increases, potentially lengthening a cycle time.

On the other hand, in a case where the movable platen 52 is moved to bring the preform 40 and the take-out tube 31 close to each other, these problems can be avoided. That is, the take-out machine 30 can be simplified and made lighter compared to a case where the take-out machine 30 is moved. In addition, the cycle time can be shortened. In addition, in a case where the movable platen 52 is moved to bring the preform 40 and the take-out tube 31 close to each other, this can be realized, for example, only by improving software of a conventional machine.

The present invention has been described above based on the embodiment. The embodiment is an exemplification, and those skilled in the art will understand that various modifications can be made for combinations of the components and processing processes, and such modifications are also within the scope of the invention.

### Modification Example 1

In the embodiment, a case where the preform 40 is moved toward the take-out tube 31 by moving the movable platen body 14 in the positive direction of the X-axis has been described. However, the present invention is not limited thereto, and the preform 40 may be relatively moved toward the take-out tube 31 by moving the take-out machine 30 in the negative direction of the X-axis. In this case, it is necessary to provide a mechanism for moving and stopping the take-out machine 30 in the X-axis direction and ensuring the position of the take-out machine 30 in the X-axis direction.

### Modification Example 2

In the embodiment, a case where the preform 40 is moved toward the take-out tube 31 by moving the movable platen body 14 in the positive direction of the X-axis has been described. However, the present invention is not limited thereto, and the preform 40 may be relatively moved toward the take-out tube 31 by moving the movable platen body 14 in the positive direction of the X-axis and moving the take-out machine 30 in the negative direction of the X-axis, that is, a direction approaching the preform 40. In this case, an amount of movement of the take-out machine 30 in the negative direction of the X-axis may be smaller than an amount of movement of the movable platen 52. For example, the amount of movement of the take-out machine 30 in the negative direction of the X-axis may be smaller than a sum of an amount of movement of the movable platen body 14 in the positive direction of the X-axis and an amount of movement of the pair of split molds 15b in the positive direction of the X-axis. In addition, for example, the amount of movement of the take-out machine 30 in the negative direction of the X-axis may be smaller than the amount of movement of the movable platen body 14 in the positive direction of the X-axis. In addition, a timing at which the movable platen body 14 and the take-out machine 30 are moved is not particularly limited. For example, the movable platen body 14 and the take-out machine 30 may be moved simultaneously, or may be moved at different times. According to the present modification example, the amount of movement of the take-out machine 30 can be reduced compared to a case where only the take-out machine 30 is moved, a mechanism for moving the take-out machine 30 can be made smaller, and an increase in the weight, that is, the inertia of the take-out machine 30, can be suppressed.

### Modification Example 3

In the embodiment, a case where the take-out machine 30 is configured to liquid-cool the preform 40 has been described. However, the present invention is not limited thereto, and the take-out machine 30 may be configured to air-cool the preform 40.

Any combination of the embodiment and modification examples described above is also useful as an embodiment of the present invention. A new embodiment that is made by the combination has effects of each of the embodiment and the modification examples that are combined. In addition, it is also understood by those skilled in the art that functions to be implemented by the respective configurational requirements described in the claims are realized by the individual components or cooperation of the respective components illustrated in the embodiment and the modification examples.

It should be understood that the invention is not limited to the above-described embodiment, but may be modified into various forms on the basis of the spirit of the invention. Additionally, the modifications are included in the scope of the invention.

What is claimed is:

1. A molding product taking-out system comprising:
a molding machine that includes a stationary platen including a stationary mold and a movable platen including a movable mold;
a take-out machine for taking out a molding product; and
a control device,
wherein the control device causes the take-out machine to enter between the stationary mold and the movable mold that are opened, and moves at least one of the movable platen and the take-out machine such that the molding product relatively approaches the take-out machine.

2. The molding product taking-out system according to claim 1,
wherein the control device moves the movable platen such that the molding product relatively approaches the take-out machine.

3. The molding product taking-out system according to claim 2,
wherein the control device moves the take-out machine such that the molding product relatively approaches the take-out machine, and
an amount of movement of the take-out machine is smaller than an amount of movement of the movable platen.

4. The molding product taking-out system according to claim 1,
wherein the control device moves at least one of the movable platen and the take-out machine such that a tip portion of the molding product is located inside the take-out machine when the molding product is no longer held in the movable mold.

5. The molding product taking-out system according to claim 1,
wherein a take-out tube of the take-out machine includes an accommodation hole for accommodating the molding product,
the accommodation hole includes a bottom portion, an inlet portion whose diameter increases toward an opening, and an intermediate portion having a cylindrical inner peripheral surface located between the bottom portion and the inlet portion, and
the control device moves at least one of the movable platen and the take-out machine such that a tip portion of the molding product is located in the intermediate portion when the molding product is no longer held in the movable mold.

6. The molding product taking-out system according to claim 1,
wherein a take-out tube of the take-out machine includes an accommodation hole for accommodating the molding product,
the accommodation hole includes a bottom portion, an inlet portion whose diameter increases toward an opening, and an intermediate portion having a cylindrical inner peripheral surface located between the bottom portion and the inlet portion,
the molding product includes a tip portion and a cylindrical portion, and
the control device moves at least one of the movable platen and the take-out machine such that at least a part of the cylindrical portion of the molding product is located in the intermediate portion when the molding product is no longer held in the movable mold.

7. The molding product taking-out system according to claim 1,
wherein the take-out machine is of a liquid-cooled type.

8. The molding product taking-out system according to claim 1, further comprising:
a robot that moves the take-out machine.

9. The molding product taking-out system according to claim 8,
wherein the robot includes a guide arm, a slide unit that is slidably attached to the guide arm, and a tip end arm attached to the slide unit.

10. The molding product taking-out system according to claim 9,
wherein the tip end arm attached to the slide unit is moved by moving the slide unit of the robot along the guide arm.

11. The molding product taking-out system according to claim 10,
wherein the take-out machine is attached to the tip end arm of the robot and reciprocates in a direction perpendicular to an opening and closing direction of a mold.

12. The molding product taking-out system according to claim 8,
wherein the control device controls the robot to move the take-out machine to a space between molds.

13. The molding product taking-out system according to claim 8,
wherein the control device controls the robot to retract the take-out machine from a space between molds.

14. A molding machine comprising:
a stationary platen including a stationary mold; and
a movable platen including a movable mold,
wherein the movable platen is movable such that a molding product approaches a take-out machine for the molding product, which enters between the stationary mold and the movable mold that are opened.

15. A control device for taking out a molding product from a molding machine that includes a stationary platen including a stationary mold and a movable platen including a movable mold, the control device being configured to:
cause a take-out machine for taking out the molding product to enter between the stationary mold and the movable mold that are opened; and
move at least one of the movable platen and the take-out machine such that the molding product relatively approaches the take-out machine.

16. A molding product taking-out method for taking out a molding product from a molding machine that includes a stationary platen including a stationary mold and a movable platen including a movable mold, the method comprising:
causing a take-out machine to enter between the stationary mold and the movable mold that are opened; and
moving at least one of the movable platen and the take-out machine such that the molding product relatively approaches the take-out machine.
